(19) United States
(12) Patent Application Publication
(10) Pub. No.: US 2024/0387951 A1
(43) Pub. Date: Nov. 21, 2024

(54) BATTERY COMPONENT AND ASSEMBLY PROCESS THEREOF

(71) Applicant: Farasis Energy (Ganzhou) Co., Ltd., Ganzhou (CN)

(72) Inventors: Jianwei Chen, Ganzhou (CN); Yuan Guo, Ganzhou (CN); Wei Liu, Ganzhou (CN); Wenliang Li, Ganzhou (CN); Xinxing Yang, Ganzhou (CN); Yiqi Huang, Ganzhou (CN); Shuiyuan Li, Ganzhou (CN)

(21) Appl. No.: 18/786,423

(22) Filed: Jul. 26, 2024

Related U.S. Application Data
(63) Continuation of application No. PCT/CN2023/127141, filed on Oct. 27, 2023.

(30) Foreign Application Priority Data
Mar. 16, 2023 (CN) 202310255085.7

(51) Int. Cl. H01M 50/503; H01M 10/613; H01M 10/6555; H01M 10/6556

(52) U.S. Cl. CPC H01M 50/503; H01M 10/613; H01M 10/6555; H01M 10/6556

(57) ABSTRACT

The present invention relates to a battery component and an assembly process thereof. The battery component includes a box body, cells, electrical connection side plates, and electrical connectors. The electrical connection side plate is installed on an inner sidewall of the box body, the electrical connector is movably assembled on the electrical connection side plate with a plurality of degrees of freedom, and an insertion/removal channel is disposed on the electrical connector. The cell is detachably disposed inside the box body, and a pole of the cell is plug-connected to the insertion/removal channel. In the present invention, repair costs are reduced, maintenance efficiency is improved, and a cell-to-module or cell-to-pack tolerance is absorbed.

### CROSS REFERENCE TO RELATED APPLICATIONS

The present application is a Continuation Application of PCT Application No. PCT/CN2023/127141 filed on Oct. 27, 2023, which claims priority to Chinese Patent Application No. 202310255085.7, filed with the China National Intellectual Property Administration on Mar. 16, 2023 and entitled “BATTERY COMPONENT AND ASSEMBLY PROCESS THEREOF”, which is incorporated herein by reference in its entirety.

### TECHNICAL FIELD

The present invention relates to the field of new energy battery technologies, and specifically, to a battery component and an assembly process thereof.

### BACKGROUND

The new energy industry is thriving, and battery systems have attracted much attention. Currently, an individual cell cannot meet an energy requirement. Therefore, final products are aggregates (box bodies and packs) formed by combining cells. During production of a battery pack with high energy density, ease of installation, safety, and ease of maintenance also have become important parts. Timely repair or even replacement of a damaged cell to control repair costs is also incorporated during evaluation of a product. In a cell-to-module or cell-to-pack process, a cell size tolerance affects module or pack formation consistency. A pre-tightening force needs to be applied to the battery pack to improve cell cycling performance.

In the conventional technology, cells are mostly connected by welding poles to electrical connectors to form electrical connection paths. For a pre-tightening force and size tolerance absorption of cells, relatively thin cell tabs are usually selected to connect to metal busbar portions of non-metal brackets for welding. In this way, when the pre-tightening force is applied, slightly bending the tabs can allow for appropriate movement.

In the conventional technology, cells are connected through welding. When a single cell is abnormal and needs to be replaced or repaired, a welded portion needs to be processed, and repair costs are high, or another cell is damaged during processing. Even repair of the single cell is impossible, and only replacement of an entire cell block is feasible. This method has relatively high repair costs. For a cell size tolerance and pre-tightening force application, a cell size difference may cause tabs to connect to each other in the cell-to-module or cell-to-pack process, posing a risk of short-circuiting. In a process of applying the pre-tightening force, because cell tabs are fixed, and during force application, the cells approach each other, resulting in a small displacement, the cell tabs are stretched. This may damage the cells.

### TECHNICAL PROBLEMS

This application is mainly intended to provide a battery component and an assembly process thereof, to resolve one or more of the following technical problems: In the conventional technology, cells are connected through welding. When a single cell is abnormal and needs to be replaced or repaired, a welded portion needs to be processed, and repair costs are high, or another cell is damaged during processing. Even repair of the single cell is impossible, and only replacement of an entire cell block is feasible. This method has relatively high repair costs. For a cell size tolerance and pre-tightening force application, a cell size difference may cause tabs to connect to each other in a cell-to-module or cell-to-pack process, posing a risk of short-circuiting. In a process of applying a pre-tightening force, because cell tabs are fixed, and during force application, the cells approach each other, resulting in a small displacement, the cell tabs are stretched. This may damage the cells.

### TECHNICAL SOLUTIONS

This application is mainly intended to provide a battery component and an assembly process thereof, to resolve one or more of the following existing technical problems: In the conventional technology, cells are connected through welding. When a single cell is abnormal and needs to be replaced or repaired, a welded portion needs to be processed, and repair costs are high, or another cell is damaged during processing. Even repair of the single cell is impossible, and only replacement of an entire cell block is feasible. This method has relatively high repair costs. For a cell size tolerance and pre-tightening force application, a cell size difference may cause tabs to connect to each other in a cell-to-module or cell-to-pack process, posing a risk of short-circuiting. In a process of applying a pre-tightening force, because cell tabs are fixed, and during force application, the cells approach each other, resulting in a small displacement, the cell tabs are stretched. This may damage the cells.

To achieve the foregoing objectives of the present invention, this application provides a battery component and an assembly process thereof.

A first aspect of this application provides a battery component, including a box body, cells, electrical connection side plates, and electrical connectors. The electrical connection side plate is installed on an inner sidewall of the box body, the electrical connector is movably assembled on the electrical connection side plate with a plurality of degrees of freedom, and an insertion/removal channel is disposed on the electrical connector. The cell is detachably disposed inside the box body, and a pole of the cell is plug-connected to the insertion/removal channel.

Based on the foregoing technical solutions, the present invention can further make the following improvements.

Further, an assembly interlayer is disposed on the electrical connection side plate, and a first through hole that communicates with the assembly interlayer is disposed on the electrical connection side plate; the electrical connector comprises a limiting sheet and an insertion/removal piece, the limiting sheet is movably assembled in the assembly interlayer with a plurality of degrees of freedom, the insertion/removal piece is fastened on the limiting sheet, and penetrates the first through hole, and the insertion/removal channel is disposed on the insertion/removal piece.

Further, a side surface of the limiting sheet elastically abuts against or is in clearance fit with an interlayer sidewall of the assembly interlayer, a buffer clearance is reserved between a first peripheral edge of the limiting sheet and a corresponding peripheral wall of the assembly interlayer, a second peripheral edge of the limiting sheet elastically abuts against a corresponding peripheral wall of the assembly interlayer, and the second peripheral edge is located on a side of an axial insertion/removal terminating end of the insertion/removal channel.

Further, a bent support structure is disposed on the limiting sheet, and an edgefold of the bent support structure elastically abuts against or is in clearance fit with the interlayer sidewall of the assembly interlayer; and
an elastic pad is further disposed on the peripheral wall of the assembly interlayer, and the second peripheral edge of the limiting sheet abuts against the elastic pad.

Further, an axial opening is disposed on the insertion/removal channel, an axial insertion/removal starting end of the insertion/removal channel is a large head end, the axial insertion/removal terminating end of the insertion/removal channel is a small head end, and the pole of the cell is axially inserted from the large head end of the insertion/removal channel.

Further, comprising pipeline limiting parts, a plurality of coolant plates, an inlet coolant pipe, and an outlet coolant pipe, wherein the pipeline limiting part is installed on a base plate or a top plate of the box body, inlets and outlets of the plurality of coolant plates are respectively connected to the inlet coolant pipe and the outlet coolant pipe, and the inlet coolant pipe and the outlet coolant pipe are respectively detachably limited in corresponding pipeline limiting parts; and an insertion/removal interval for accommodating the cell is reserved between two adjacent coolant plates, and the cell is disposed in the insertion/removal interval.

Further, a hanging channel is further disposed on the electrical connection side plate, and an extension direction of the hanging channel is the same as an extension direction of the insertion/removal channel; and a hanging block is disposed on a side edge of the coolant plate, and the hanging block is plug-connected to the hanging channel.

Further, a pipeline groove arranged perpendicularly to the coolant plate is disposed on the pipeline limiting part, a groove opening of the pipeline groove is disposed toward the insertion/removal channel, and an avoidance notch for accommodating a corner of the cell is disposed on a groove wall of the pipeline groove.

Further, the coolant plate is a flexible coolant plate.

Further, a plurality of rows of second through holes are further disposed on a base plate of the box body, each row of second through holes comprises at least one second through hole, a spring is connected to the base plate at each second through hole, the spring is disposed in correspondence with the second through hole, and the spring protrudes from a side surface of the base plate.

Further, the second through hole and the spring are formed on the base plate by using a stamping process.

Further, a pressing plate is further disposed in the box body, and the pressing plate is press-fitted on a top edge of the cell.

Further, the limiting sheet uses a flexible cable, and the insertion/removal piece uses a hard cable.

The second aspect of this application proposes an assembly process of the battery component, comprising the following steps:
S1. assembling the pipeline limiting part on the base plate or the top plate of the box body; and fastening the electrical connection side plate to the inner sidewall of the box body; or
S1′. fastening the electrical connection side plate to the inner sidewall of the box body; and assembling the pipeline limiting part on the base plate or the top plate of the box body; and
S2. assembling the coolant plates and the cells in the box body; respectively installing, in the pipeline limiting parts, the inlet coolant pipe and the outlet coolant pipe that are connected to the plurality of coolant plates, and inserting the cell into an insertion/removal interval between two adjacent coolant plates, so that the pole of the cell is plug-connected to the insertion/removal channel of the electrical connector; or
S2′: assembling the coolant plates and the cells in the box body; and inserting the cell into the insertion/removal channel of the electrical connector, wherein a coolant plate insertion/removal clearance is reserved between adjacent cells, and respectively inserting the plurality of coolant plates into corresponding coolant plate insertion/removal clearances while enabling the inlet coolant pipe and the outlet coolant pipe that are connected to the plurality of coolant plates to be respectively installed in the pipeline limiting parts.

### BENEFICIAL EFFECTS

In the present invention, an electrical connection side plate and an electrical connector that are separately disposed are used, and the electrical connector is movably assembled on the electrical connection side plate, so that a pole of a cell can be detachably disposed in an insertion/removal channel, and a single cell can be pulled out when the single cell needs to be replaced or repaired because the cell fails or a problem occurs on the cell, thereby reducing repair costs and improving maintenance efficiency. In addition, a problem of poor module or pack formation that may be caused by a cell size deviation in a cell-to-module or cell-to-pack process is resolved, a risk of damage to the cell is reduced, and a cell-to-module or cell-to-pack tolerance. An assembly interlayer and a through hole are disposed, so that a limiting sheet is easily limited in the assembly interlayer, and can move in the assembly interlayer, and then the pole of the cell is plug-connected to and fitted with an insertion/removal piece, so that assembly is easy, and the assembly structure is compact and reliable. Disposing a buffer clearance helps the limiting sheet move within the assembly interlayer. An inlet coolant pipe and an outlet coolant pipe are detachably disposed in pipeline limiting parts, so that assembly is easy. A coolant plate may be hung to the electrical connection side plate, so that assembly is easy. Disposing an avoidance notch can not only avoid a corner of the cell, but also limit the corner of the cell to some extent, making the assembly structure of the cell more stable. A value of water pressure in the coolant plate may be changed as required, to adjust a pre-tightening acting force between the coolant plate and the cell. A plurality of rows of through holes are disposed on a base plate, and a spring is disposed at each through hole, so that when the cell is placed on the base plate, an elastic force of the spring can be used to provide specific elasticity adjustment space for a height of the cell, thereby easily adjusting a height difference between different cells and absorbing a tolerance between the cells. In addition, the spring protrudes from the base plate, so that a specific clearance is further reserved between the cell and the base plate, thereby improving a heat dissipation capability of an entire battery pack. Unlike glue or a rubber pad, which restricts movement of the cell, the spring structure does not restrict the movement of the cell, and therefore, subsequently, the cell can be removed very easily if the cell needs to be replaced or repaired. Using a stamping process to form through holes and springs makes the process simple and the through holes and the springs quickly formed. In addition, the formed springs have consistent structures, and can provide effective and stable structural support for cells. In addition, connections in an assembly process, a cell-to-module or cell-to-pack process, and a coolant system in the present invention are all performed in an insertion/removal manner, and therefore, a cell may be physically detached for replacement when a problem occurs on the cell. Compared with welding, this manner can enable related parts to be reused. In addition, the electrical connection side plate can absorb a cell size tolerance, so that a risk that the pole is torn due to a force and a risk of damage to the cell are reduced. Using a tapered structure helps limit the pole of the cell during insertion.

### BRIEF DESCRIPTION OF DRAWINGS

FIG. 1 is a schematic exploded diagram of a three-dimensional structure of a battery component according to the present invention;

FIG. 2 is a schematic structural diagram 1 in which a cell is inserted into an insertion/removal piece according to the present invention;

FIG. 3 is a schematic diagram of an enlarged structure of a part A in FIG. 2;

FIG. 4 is a schematic structural diagram 2 in which a cell is inserted into an insertion/removal piece according to the present invention;

FIG. 5 is a schematic diagram of an enlarged structure of a part B in FIG. 4;

FIG. 6 is a schematic structural diagram 3 in which a cell is inserted into an insertion/removal piece according to the present invention;

FIG. 7 is a schematic diagram of an enlarged structure of a part C in FIG. 6;

FIG. 8 is a schematic diagram of a three-dimensional structure of a plurality of coolant plates according to the present invention;

FIG. 9 is a schematic structural diagram 1 in which a coolant plate fits with a cell according to the present invention;

FIG. 10 is a schematic structural diagram 2 in which a coolant plate fits with a cell according to the present invention;

FIG. 11 is a schematic exploded diagram of a three-dimensional structure in which an electrical connection side plate fits with an electrical connector according to the present invention;

FIG. 12 is a schematic diagram of an enlarged structure of a part D in FIG. 11;

FIG. 13 is a schematic structural side view in which an electrical connection side plate fits with an electrical connector according to the present invention;

FIG. 14 is a schematic diagram of a three-dimensional structure of an electrical connector according to the present invention;

FIG. 15 is a schematic diagram of a partial structure of a box body according to the present invention;

FIG. 16 is a schematic diagram of a three-dimensional structure in which a pipeline limiting part is installed in a box body according to the present invention;

FIG. 17 is a schematic diagram of a three-dimensional structure in which a connection side plate is installed on a side plate of a box body according to the present invention;

FIG. 18 is a schematic diagram of a three-dimensional structure in which a sampling plate is installed on an electrical connection side plate according to the present invention;

FIG. 19 is a schematic diagram of a three-dimensional structure in which a coolant plate is installed in a box body according to the present invention;

FIG. 20 is a schematic diagram of a three-dimensional structure in which a partition plate is installed according to the present invention;

FIG. 21 is a schematic diagram of a three-dimensional structure in which a cell is installed according to the present invention;

FIG. 22 is a schematic diagram of a three-dimensional structure in which a pressing plate is installed according to the present invention;

FIG. 23 is a schematic diagram of a three-dimensional structure in which a top plate and an end plate are installed according to the present invention;

FIG. 24 is a schematic diagram of a three-dimensional structure of a battery component according to the present invention;

FIG. 25 is a schematic structural diagram 1 of a base plate of a box body according to the present invention;

FIG. 26 is a schematic diagram of an enlarged structure of a part A in FIG. 25;

FIG. 27 is a schematic structural diagram 1 in which a cell fits with a base plate according to the present invention;

FIG. 28 is a schematic diagram of an enlarged structure of a part B in FIG. 27;

FIG. 29 is a schematic structural diagram 2 of a base plate of a box body according to the present invention;

FIG. 30 is a schematic diagram of an enlarged structure of a part C in FIG. 29;

FIG. 31 is a schematic structural diagram 2 in which a cell fits with a base plate according to the present invention;

FIG. 32 is a schematic diagram of an enlarged structure of a part D in FIG. 31; and

FIG. 33 is a schematic exploded diagram of a three-dimensional structure of a box body according to the present invention.

In the accompanying drawings, a list of components represented by reference numerals is as follows:
100. base plate; 101. side plate; 102. top plate; 103. partition plate; 104. electrical connection side plate; 105. assembly interlayer; 106. first through hole; 107. limiting sheet; 108. insertion/removal piece; 109. buffer clearance; 110. elastic pad; 111. large head end; 112. small head end; 113. hanging channel; 114. pressing plate; 115. guide post; 116. end plate; 117. plastic base plate; 118. plastic cover plate; 119. bent support structure; 120. avoidance port; 121. pressing edge; 200. cell; 201. pole; 202. corner; 300. pipeline limiting part; 301. coolant plate; 302. inlet coolant pipe; 303. outlet coolant pipe; 305. hanging block; 306. pipeline groove; 307. avoidance notch; 400. sampling plate; 11. second through hole; 12. spring; 13. free end; 14. arc structure; 15. a row of through holes; 16. planar structure; and 31. non-pole side.

### DESCRIPTION OF EMBODIMENTS

The following describes the principles and features of the present invention with reference to the accompanying drawings. The examples are merely used to explain the present invention, and are not intended to limit the scope of the present invention.

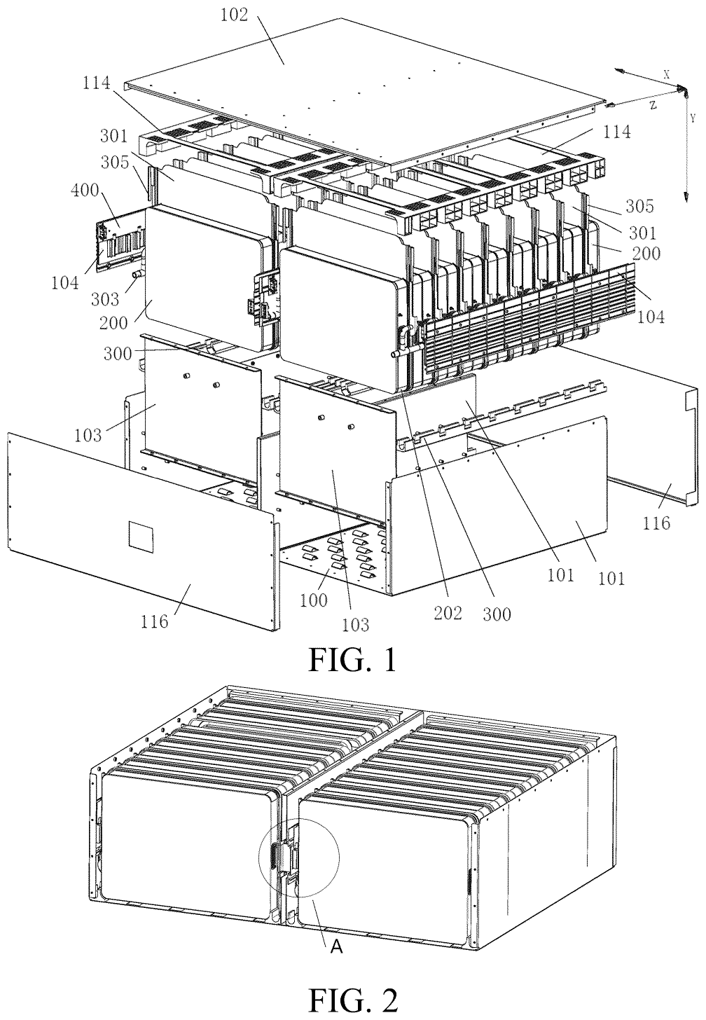

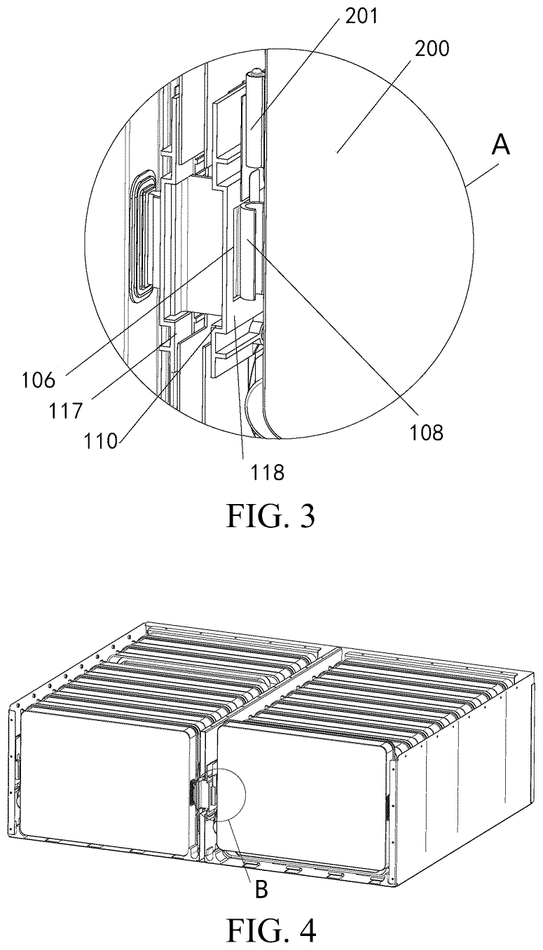

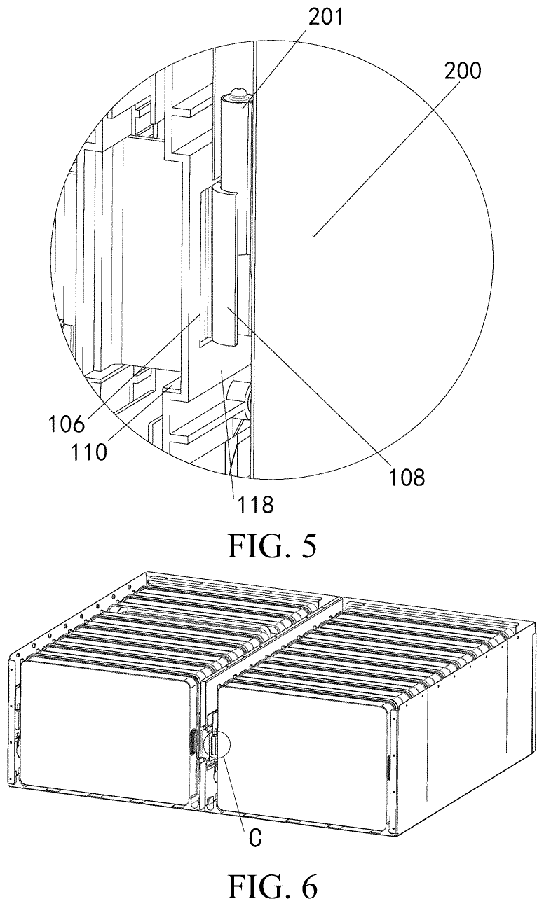

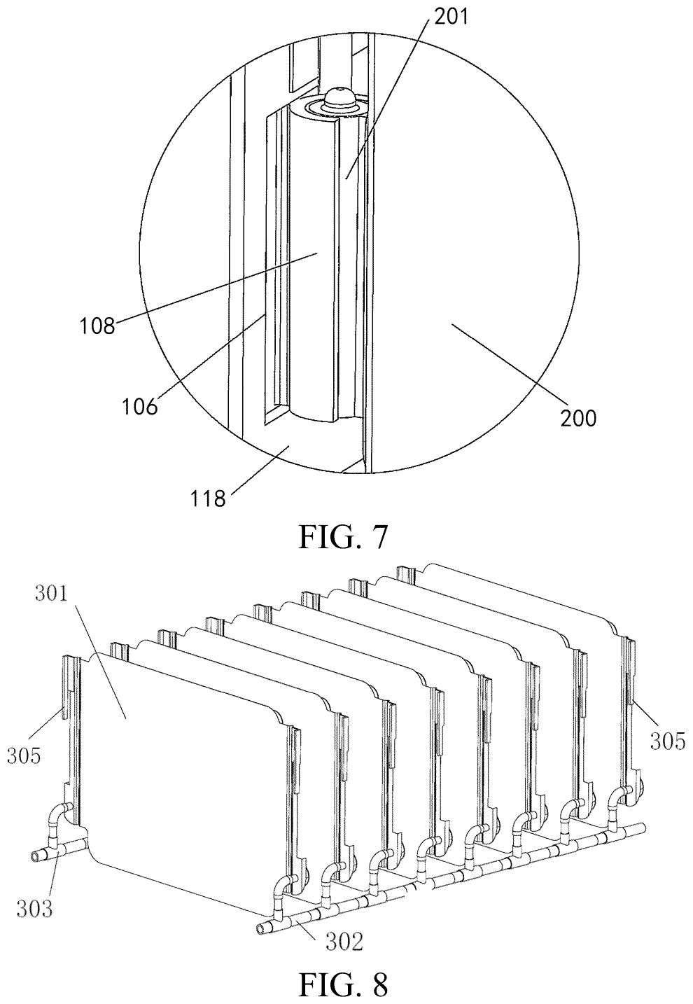

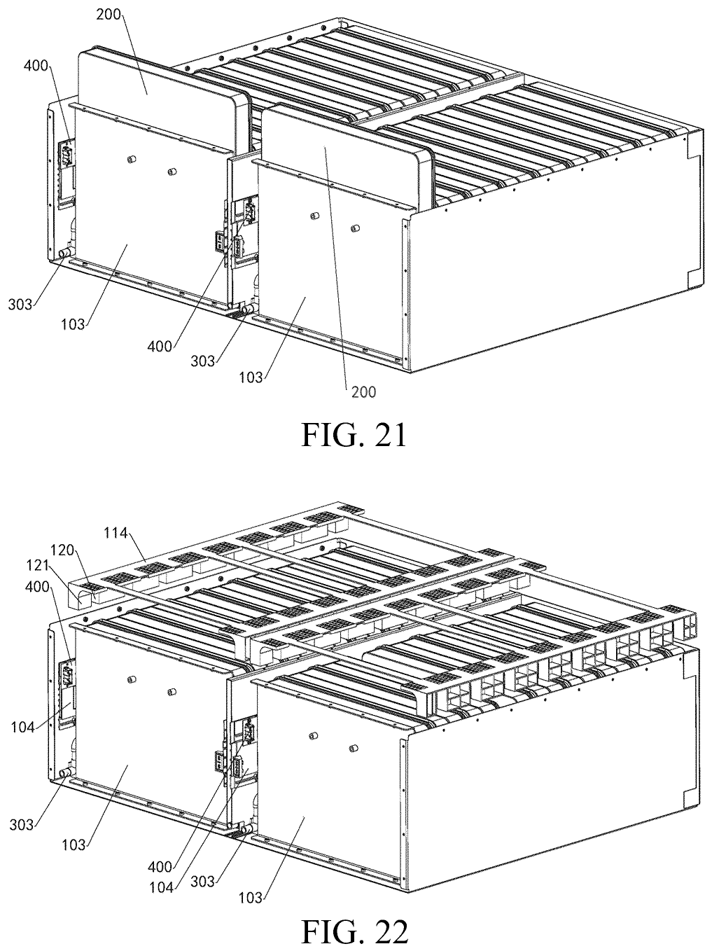

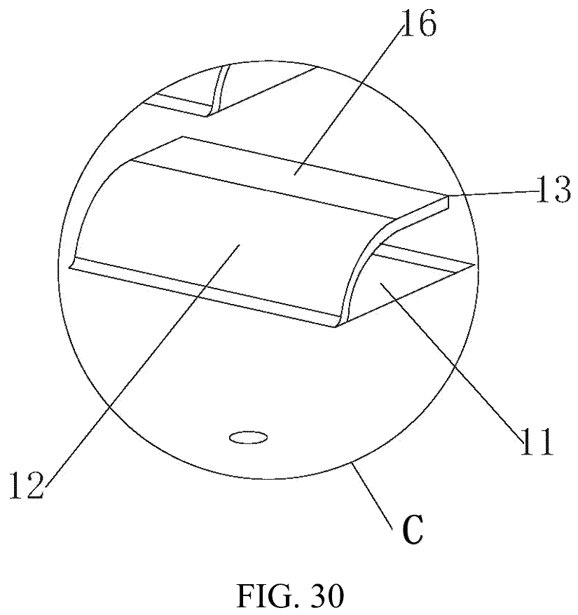

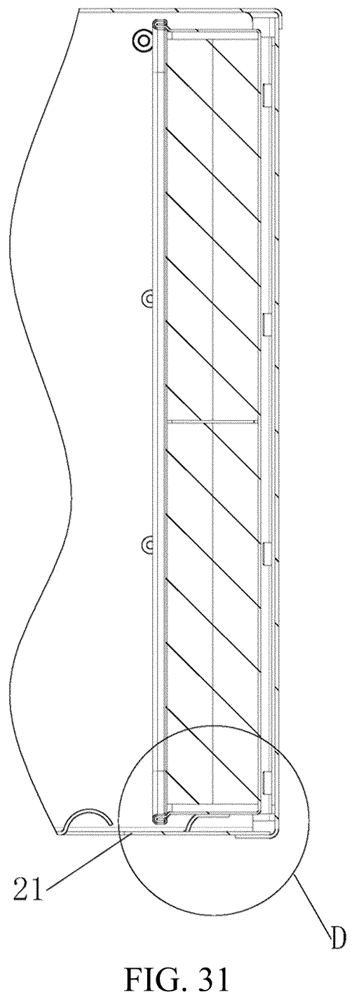

As shown in FIG. 1 to FIG. 33, a battery component in the embodiments includes a box body, cells 200, electrical connection side plates 104, and electrical connectors. The electrical connection side plate 104 is installed on an inner sidewall of the box body, the electrical connector is movably assembled on the electrical connection side plate 104 with a plurality of degrees of freedom, and an insertion/removal channel is disposed on the electrical connector. The cell 200 is detachably disposed inside the box body, and a pole 201 of the cell 200 is plug-connected to the insertion/removal channel.

The electrical connection side plate 104 in the embodiments may be made of any insulation material with specific toughness and strength.

The electrical connector is installed on the electrical connection side plate 104 with a plurality of degrees of freedom. Specifically, the electrical connector may be limited on the electrical connection side plate 104, and can move within a specific range. In an example of six degrees of freedom indicated by X, Y, and Z coordinate axes in FIG. 1 (each coordinate axis has two degrees of freedom), the electrical connector can move in any two or more degrees of freedom directions relative to the electrical connection side plate 104.

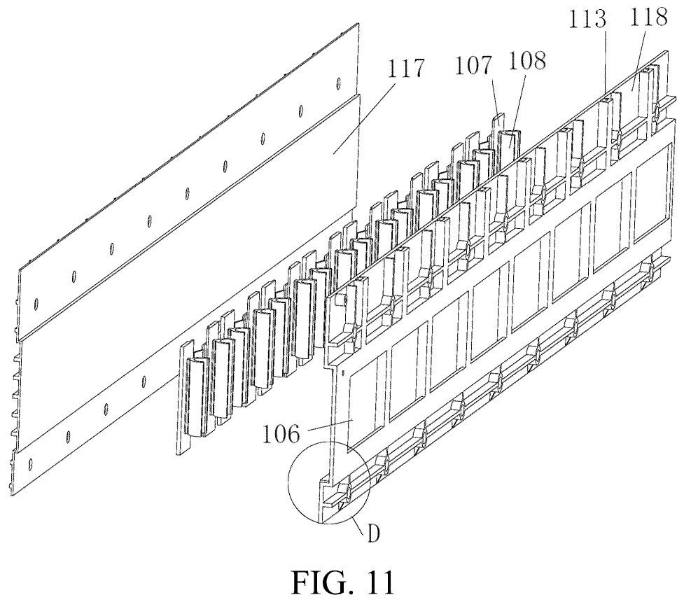

As shown in FIG. 11 to FIG. 14, in the embodiments, an assembly interlayer 105 is disposed on the electrical connection side plate 104, and a first through hole 106 that communicates with the assembly interlayer 105 is disposed on the electrical connection side plate 104. The electrical connector includes a limiting sheet 107 and an insertion/removal piece 108, the limiting sheet 107 is movably assembled in the assembly interlayer 105 with a plurality of degrees of freedom, and is in clearance fit with an inner sidewall of the assembly interlayer 105 (this clearance is quite small, which can ensure that the limiting sheet 107 is movable without pulling the pole of the cell to a great extent), the insertion/removal piece 108 is fastened on the limiting sheet 107, and penetrates the first through hole 106, and the insertion/removal channel is disposed on the insertion/removal piece 108. The assembly interlayer and the first through-hole are disposed, so that a limiting sheet is easily limited in the assembly interlayer, and can move in the assembly interlayer, and then the pole of the cell is plug-connected to and fitted with the insertion/removal piece, so that assembly is easy, and the assembly structure is compact and reliable.

Specifically, in the embodiments, the limiting sheet 107 may use a flexible cable, and the insertion/removal piece 108 may use a hard cable. In other words, structural strength of the insertion/removal piece 108 is greater than that of the limiting sheet 107, and toughness of the limiting sheet 107 is greater than that of the insertion/removal piece, so that the pole of the cell is easily inserted into/removed from the insertion/removal channel of the insertion/removal piece, and the limiting sheet 107 is easily in clearance fit with the assembly interlayer 105. In addition, a single-parallel-multiple-serial connection manner is provided in FIG. 11 of the embodiments. A multiple-parallel-multiple-serial connection manner may alternatively be designed as required. In addition, the pole of the cell and the insertion/removal channel of the insertion/removal piece in the embodiments may be in any shape and be connected in any manner. For example, the pole of the cell may be in a shape of a square cylinder, a cylinder, an elliptical cylinder, or the like.

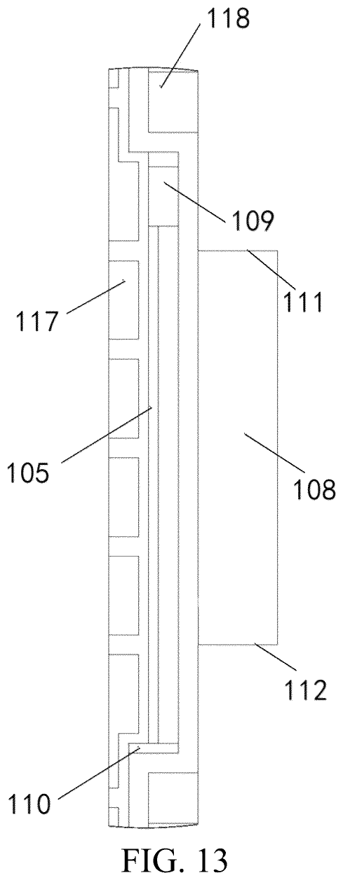

As shown in FIG. 11 and FIG. 13, in the embodiments, a side surface of the limiting sheet 107 elastically abuts against an interlayer sidewall of the assembly interlayer 105, a buffer clearance 109 is reserved between a first peripheral edge of the limiting sheet 107 and a corresponding peripheral wall of the assembly interlayer 105, a second peripheral edge of the limiting sheet 107 elastically abuts against a corresponding peripheral wall of the assembly interlayer 105, and the second peripheral edge is located on a side of an axial insertion/removal terminating end of the insertion/removal channel. Disposing the buffer clearance helps the limiting sheet move in the assembly interlayer, to resolve a problem of poor module or pack formation that may be caused by a cell size deviation in the cell-to-module or cell-to-pack process, reduce a risk of damage to the cell, and absorb a cell-to-module or cell-to-pack tolerance.

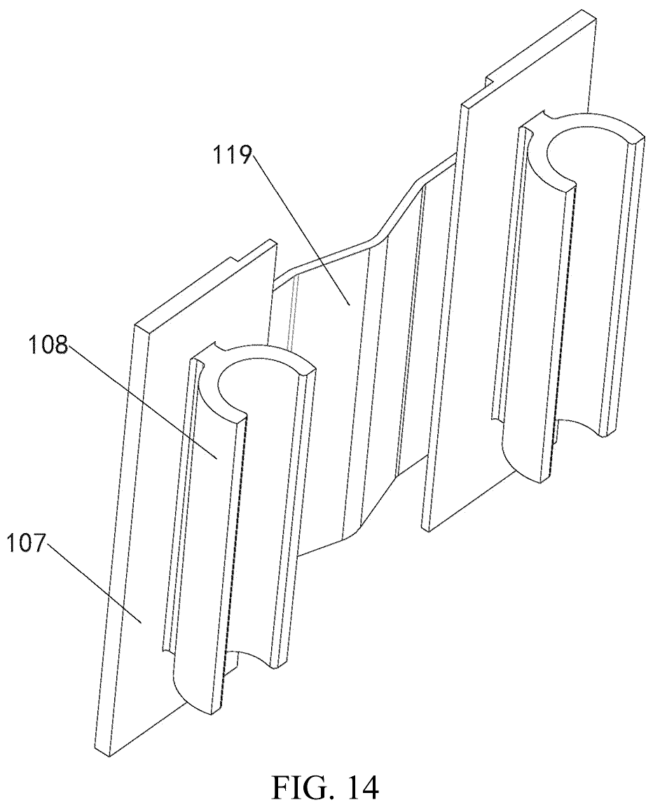

As shown in FIG. 14, in the embodiments, a bent support structure 119 is disposed on the limiting sheet 107, and an edgefold of the bent support structure 119 elastically abuts against or is in clearance fit with the interlayer sidewall of the assembly interlayer 105 (this clearance is quite small, which can ensure that the limiting sheet 107 is movable without pulling the pole of the cell to a great extent).

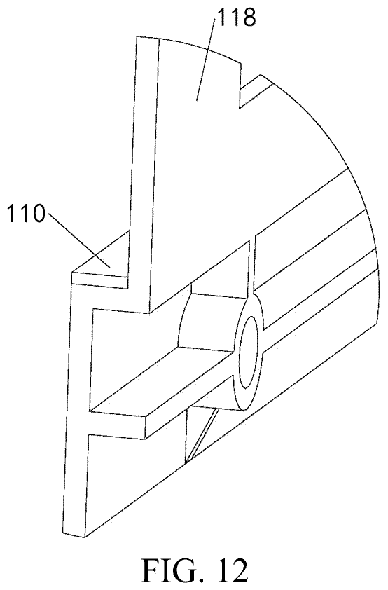

As shown in FIG. 12 and FIG. 13, in the embodiments, an elastic pad 110 is further disposed on the peripheral wall of the assembly interlayer 105, and the second peripheral edge of the limiting sheet 107 abuts against the elastic pad 110.

As shown in FIG. 2 to FIG. 7, in the embodiments, an axial opening is disposed on the insertion/removal channel, an axial insertion/removal starting end of the insertion/removal channel is a large head end 111, the axial insertion/removal terminating end of the insertion/removal channel is a small head end 112, and the pole 201 of the cell 200 is axially inserted from the large head end 111 of the insertion/removal channel. Using a tapered structure helps limit the pole of the cell during insertion.

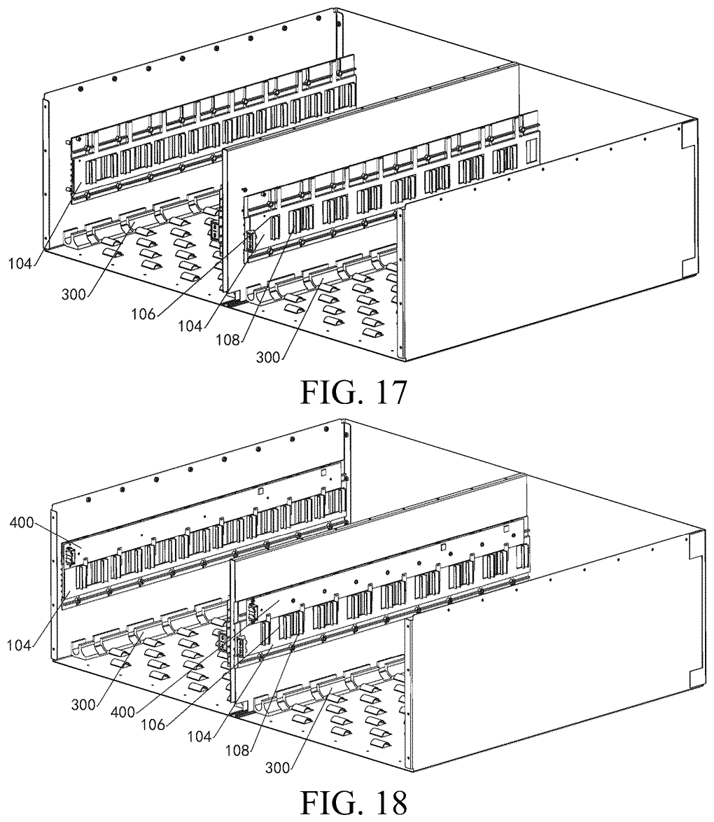

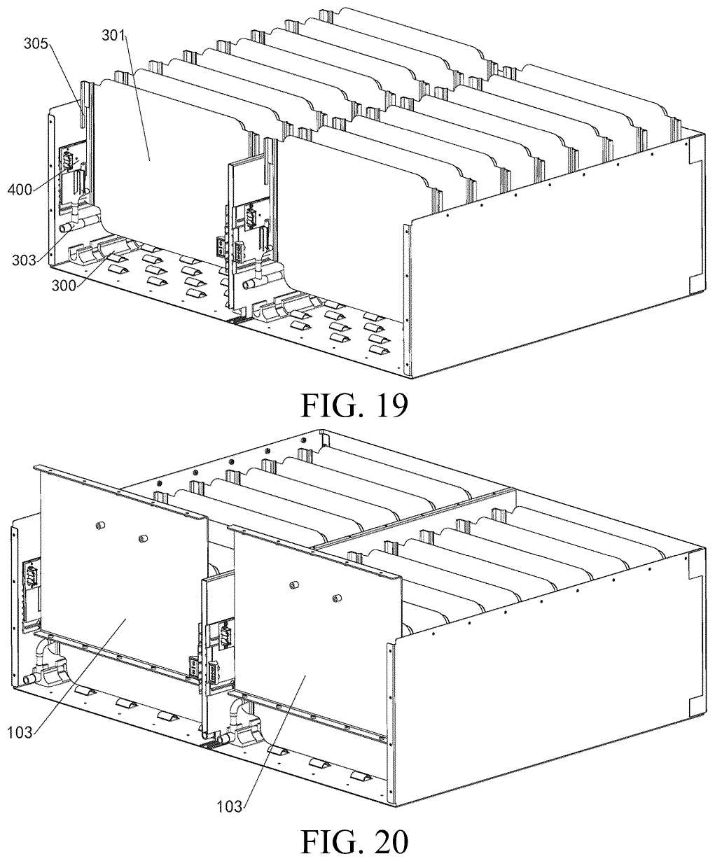

As shown in FIG. 8, FIG. 16, FIG. 17, FIG. 18, and FIG. 19, in the embodiments, the battery component further includes pipeline limiting parts 300, a plurality of coolant plates 301, an inlet coolant pipe 302, and an outlet coolant pipe 303. The pipeline limiting part 300 is installed on a base plate 100 or a top plate 102 of the box body, inlets and outlets of the plurality of coolant plates 301 are respectively connected to the inlet coolant pipe 302 and the outlet coolant pipe 303, and the inlet coolant pipe 302 and the outlet coolant pipe 303 are respectively detachably limited in corresponding pipeline limiting parts 300. An insertion/removal interval for accommodating the cell 200 is reserved between two adjacent coolant plates 301, and the cell 200 is disposed in the insertion/removal interval. The inlet coolant pipe and the outlet coolant pipe are detachably disposed in the pipeline limiting parts, so that assembly is easy.

As shown in FIG. 8 to FIG. 11, in the embodiments, a hanging channel 113 is further disposed on the electrical connection side plate 104, and an extension direction of the hanging channel 113 is the same as an extension direction of the insertion/removal channel. A hanging block 305 is disposed on a side edge of the coolant plate 301, and the hanging block 305 is adapted to be plug-connected to the hanging channel 113. The coolant plate may be hung to the electrical connection side plate, so that assembly is easy.

In the embodiments, the electrical connection side plates 104 may have an integrally formed structure or a split structure. The embodiments provide a preferred structural form. The electrical connection side plate 104 includes a plastic base plate 117 and a plastic cover plate 118. As shown in FIG. 11 to FIG. 13, a protrusion is formed in the middle of the plastic base plate 117, and a recess is formed in the middle of the plastic cover plate 118. When the plastic base plate 117 and the plastic cover plate 118 are interconnected, the protrusion is inserted into the recess, and a clearance, namely, the assembly interlayer 105, is reserved. Then the limiting sheet 107 of the electrical connector is in clearance fit with and is limited in the assembly interlayer 105. A recess position of the plastic cover plate 118 is further provided with a plurality of first through holes 106 that are used for insertion/removal pieces to penetrate. Then a hollow plug-connection post is disposed on a side of the plastic cover plate 118 that is away from the plastic base plate 117, the hanging channel 113 is formed in the hollow plug-connection post, and the hanging channel 113 is located above the first through hole 106. Then the elastic pad 110 may be disposed at the bottom of the recess. The limiting sheet 107 abuts against the elastic pad 110, and the buffer clearance 109 is reserved at an upper end of the limiting sheet 107 and the top of the recess. The cell is inserted from top to down in a Y-axis direction. A fitting tolerance between the pole of the cell and the insertion/removal channel may cause a cell-to-module or cell-to-pack height difference. However, all of the spring 12 on the base plate of the box body, the elastic pad 110 on the plastic cover plate, and the buffer clearance of the assembly interlayer 105 can absorb a tolerance in a height direction. When the cell is pressed to make the pole to closely fit with the insertion/removal channel, both the spring on the base plate and the elastic pad 110 on the plastic cover plate are deformed due to a force. After the pressing force is withdrawn, both the spring on the base plate and the clastic pad 110 on the plastic cover plate may rebound to some extent, without affecting a close connection between the pole of the cell and the electrical connector. The limiting sheet can properly move in the assembly interlayer in each of X, Y, and Z directions. When a position deviation or a size deviation occurs between two sides of the pole of the cell, the electrical connector may move in the X, Y, or Z direction to absorb the tolerance. When the coolant plate expands and squeezes the cell, the coolant plate provides a pre-tightening force for the cell-to-module or cell-to-pack process, and can better fit with the cell, to dissipate heat of the cell when the cell works. Leftward/rightward displacement that is of the cell in a direction perpendicular to a large surface and that is caused by the generated pre-tightening force can be absorbed by compression deformation of the bent support structure of the electrical connector.

As shown in FIG. 17 to FIG. 19, in the embodiments, a pipeline groove 306 arranged perpendicularly to the coolant plate 301 is disposed on the pipeline limiting part 300, a groove opening of the pipeline groove 306 is disposed toward the insertion/removal channel, and an avoidance notch 307 for accommodating a corner 202 of the cell 200 is disposed on a groove wall of the pipeline groove 306. Disposing the avoidance notch can not only avoid the corner of the cell, but also limit the corner of the cell to some extent, making the assembly structure of the cell more stable.

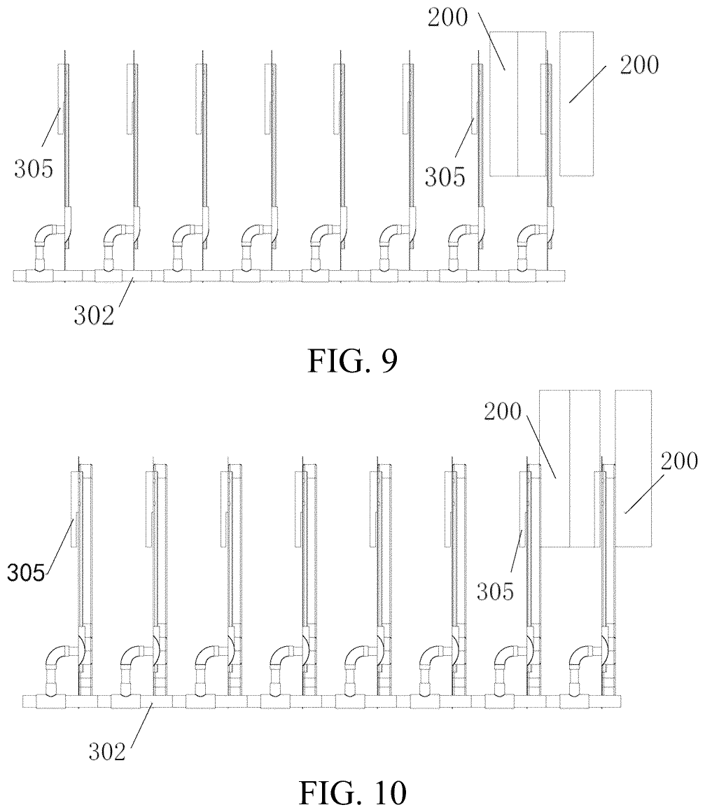

In a preferred solution of the embodiments, as shown in FIG. 9 and FIG. 10, the coolant plate 301 in the embodiments is a flexible coolant plate. The flexible coolant plate is used. When a coolant medium is filled, the flexible coolant plate is bulged, and a large surface of the coolant plate can better fit with a surface of the cell, so that cooling efficiency is improved while a pre-tightening force is applied to the cell.

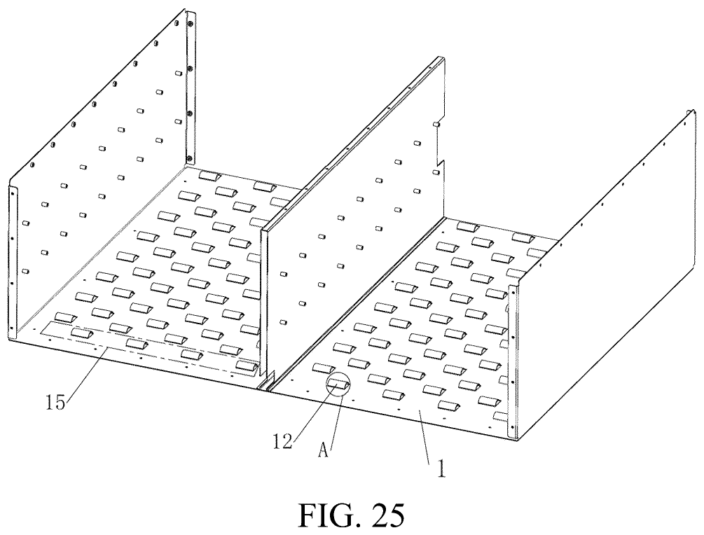

To better adjust a height of the cell, as shown in FIG. 25 to FIG. 33, in the embodiments, a plurality of rows of second through holes 11 are further disposed on the base plate 100 of the box body, each row of second through holes 11 includes at least one second through hole 11, a spring 12 is connected to the base plate 100 at each second through hole 11, the spring 12 is disposed in correspondence with the second through hole 11, and the spring 12 protrudes from a side surface of the base plate 100. The plurality of rows of second through holes are disposed on the base plate, and the spring is disposed at each through hole, so that when the cell is placed on the base plate, an elastic force of the spring can be used to provide specific elasticity adjustment space for the height of the cell, thereby easily adjusting a height difference between different cells and absorbing a tolerance between the cells. In addition, the spring protrudes from the base plate, so that a specific clearance is further reserved between the cell and the base plate, thereby improving a heat dissipation capability of an entire battery pack. Unlike glue or a rubber pad, which restricts movement of the cell, the spring structure does not restrict the movement of the cell, and therefore, subsequently, the cell can be removed very easily if the cell needs to be replaced or repaired.

Specifically, each row of through holes 11 may include only one through hole 11, or may include a plurality of through holes 11. Quantities of different rows of through holes 11 may be the same or different. Generally, to provide same stable support for cells, quantities of different rows of through holes 11 may be the same. The base plate 100 may be of a flat plate-shaped structure or a U-shaped structure, and the through hole 11 is disposed on the flat plate-shaped structure or a bottom wall of the U-shaped structure.

In the embodiments, the spring 12 is welded, bonded, integrally connected, or fastened, by using a connector, to the base plate 100. The spring may be connected to the base plate in any fastening manner.

As shown in FIG. 25, in an optional solution of the embodiments, the spring 12 is connected to an inner sidewall of a corresponding through hole 11. The spring is disposed on an inner sidewall of a region in which the through hole 11 is located, so that the spring can be welded to the inner sidewall of the through hole, or can be integrally connected to the inner sidewall of the through hole, without occupying space of a side surface of the base plate, and therefore, structural design is more proper.

In a preferred solution of the embodiments, the spring 12 is integrally connected to an inner sidewall of each through hole 11. The spring is integrally connected to the inner sidewall of the through hole, which is similar to an open door structure, so that other additional steps are reduced, and the through hole and the spring can be formed through direct cutting or stamping.

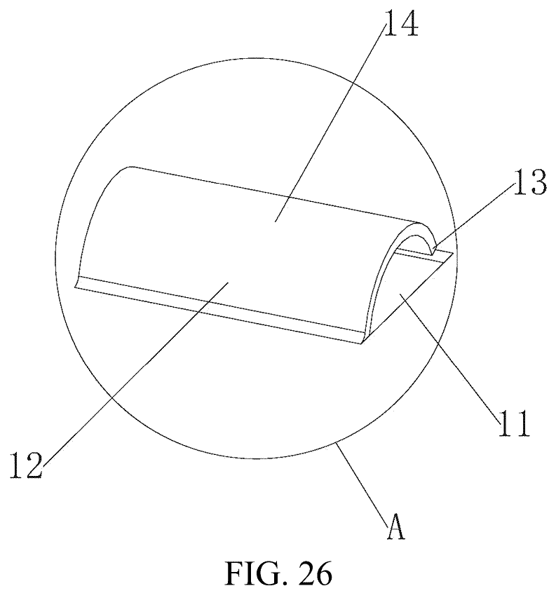

As shown in FIG. 25 and FIG. 26, the spring 12 uses a structure that is tilted toward the inside of the base plate 100, and the spring 12 may have any structure and shape. The middle of the spring is tilted toward a side surface of the base plate, and the spring can support the cell, so that contact between the spring and the cell can be more stable, and after the spring is pressed, the through hole can provide specific pressure accommodating space for the spring.

As shown in FIG. 26, preferably, a portion of the spring 12 that is close to a free end 13 of the spring 12 is an arc structure 14 or a planar structure 16. The arc structure 14 may be a circular arc structure, an elliptical arc structure, another irregular arc structure, or the like. The spring using the arc structure 14 achieves a better elastic support effect. The spring using the planar structure can provide a better support effect for the cell. The spring 12 may use any material with elasticity, for example, may use a metal material, a hard plastic material, a metal-plastic combination structure, a metal-rubber combination structure, or a plastic-rubber combination structure.

As shown in FIG. 25, in a further solution of the embodiments, two adjacent rows of through holes 11 are staggered, so that stress of the base plate is prevented from being excessively concentrated. In addition, the staggered through holes can ensure that springs of each row of through holes can support the cell. Two adjacent rows of through holes 11 may be staggered at an interval of one through hole 11 (to be specific, one through hole 11 exactly corresponds to an interval between two through holes 11 in an adjacent row of through holes), or may be staggered at an interval of two through holes 11. In this way, the through holes 11 on the base plate are distributed more uniformly.

As shown in FIG. 25 and FIG. 26, preferably, a shape of the spring 12 matches a shape of the through hole 11. Because the spring 12 and the through hole 11 may be formed through cutting or stamping, generally, a size and the shape of the spring 12 should be equivalent to a size and the shape of the through hole 11. To meet another requirement (for example, heat dissipation), the size of the spring 12 may be set to be relatively small. In this way, when pressure on the spring is excessively large, the spring can be pressed into and accommodated in the through hole.

In a preferred solution of the embodiments, the through hole 11 and the spring 12 are formed on the base plate 100 by using a stamping process. Using the stamping process to form through holes and springs makes the process simple and the through holes and the springs quickly formed. In addition, the formed springs have consistent structures, and can provide effective and stable structural support for cells. Stamping is a formation processing method that relies on presses and molds to apply external forces to plates, strips, pipes, and profiles to cause plastic deformation or separation, so as to obtain workpieces (stamping parts) of desired shapes and sizes.

As shown in FIG. 29, in the embodiments, the box body includes the top plate 102, the base plate 100, an end plate 116, and side plates 101. As shown in FIG. 25 and FIG. 29, in the embodiments, the top plate 102, the base plate 100, the end plate 116, and the side plates 101 may be detachably connected to each other. Alternatively, the base plate 100 and the two side plates 101 may be disposed as an integral structure. To be specific, a plate is bent to form the base plate 100, a left side plate, and a right side plate, and then a partition plate 103 and the end plate 116 are fastened on the base plate 100, the left side plate, and the right side plate, so that a clearance for assembling an electrical element is reserved between the partition plate 103 and the end plate 116. The top plate 102 is installed after assembly of the entire battery pack is completed. Because the spring is disposed at the bottom or top of the box body, a spring structure at the bottom of the box body can provide a same effect as glue/a soft rubber pad in a case of a small contact area.

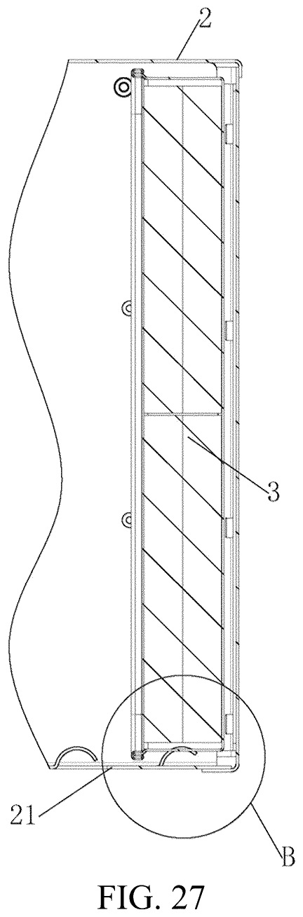

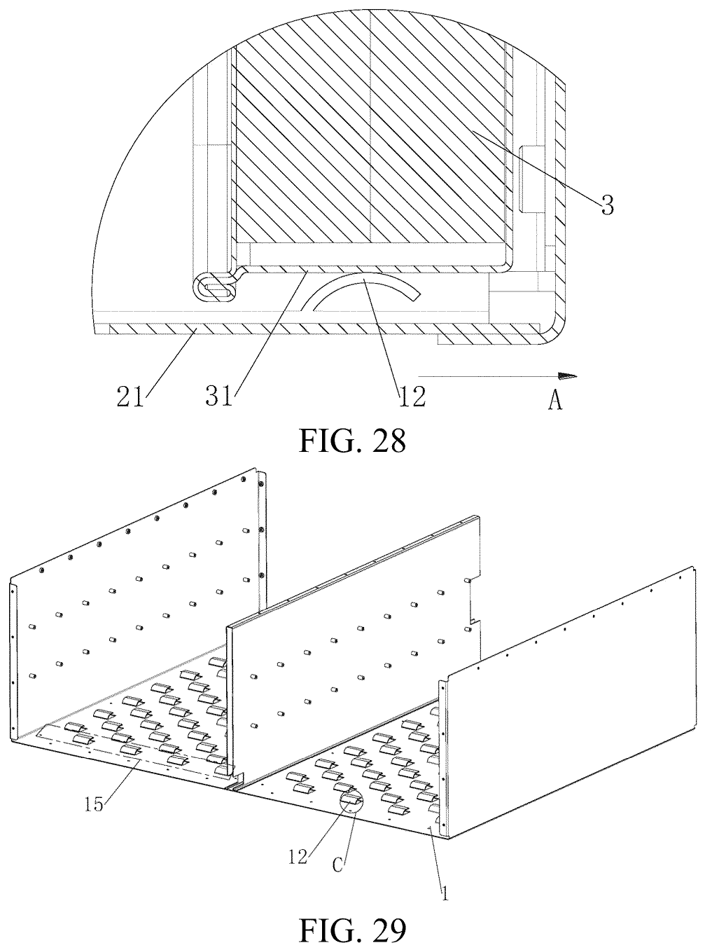

As shown in FIG. 27 and FIG. 28, the cell 200 is installed in the box body, and a non-pole side 31 of a peripheral wall of the cell 200 corresponds to a row of through holes 15, and abuts against springs 12 at the row of through holes 15. A pole side of the cell 200 may be opposite to the non-pole side 31, or may be adjacent to the non-pole side 31. FIG. 28 is a schematic diagram in which the non-pole side 31 of the cell 200 abuts against the spring 12. One cell 200 in the entire battery pack can abut against the spring 12, or all cells 200 can abut against springs 12.

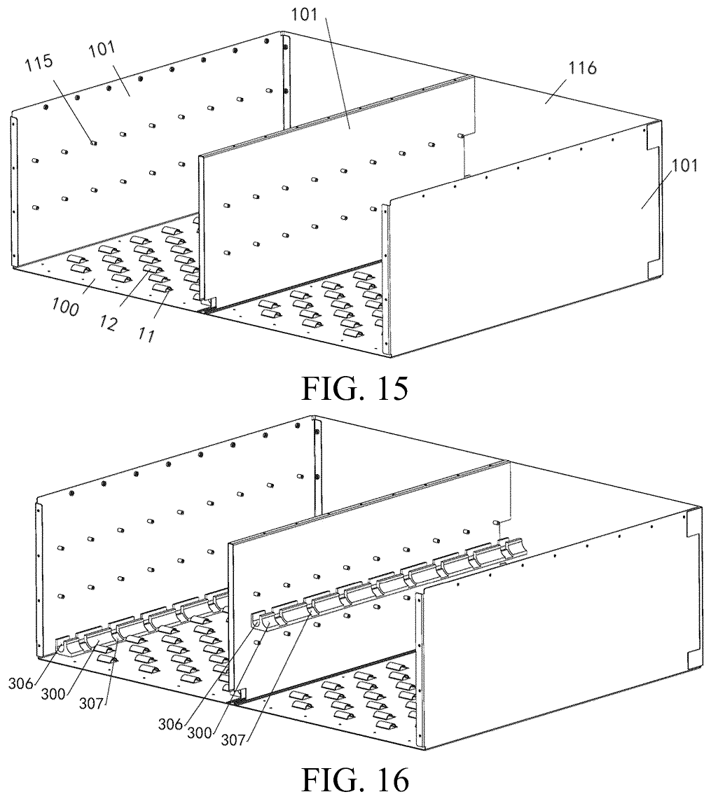

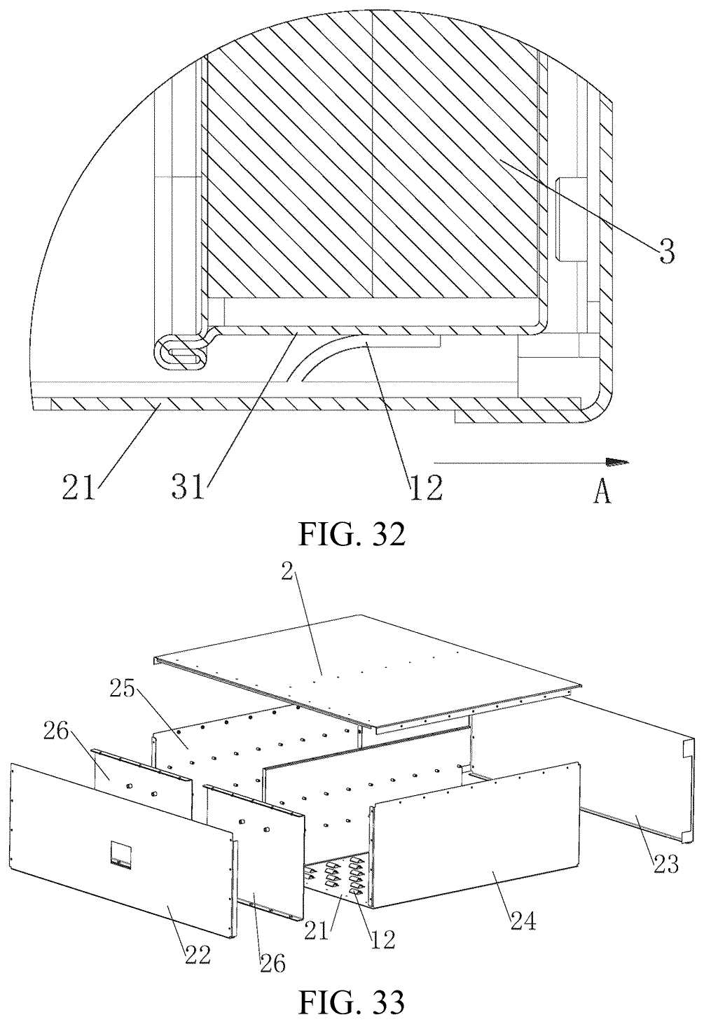

In addition, the spring 12 may have an opening at any angle relative to an arrangement direction of the cell 200. An opening direction of the spring 12 shown in FIG. 29 and FIG. 32 is perpendicular to a large surface of the cell 200. Certainly, in addition to an opening direction (a direction indicated by an arrow A in FIG. 32) of the spring 12 in FIG. 15 and FIG. 32, the opening direction of the spring 12 may be set to be parallel to the large surface of the cell 200, or may be set to deviate by any angle. In both cases, an elastic support function for the cell can be fulfilled. In addition, opening directions of all springs 12 may be the same or different, which does not affect an elastic support effect on the cell. To facilitate stamping, the opening directions of the springs 12 are usually set to be the same, in other words, opening directions of all springs 12 in FIG. 1 are the same.

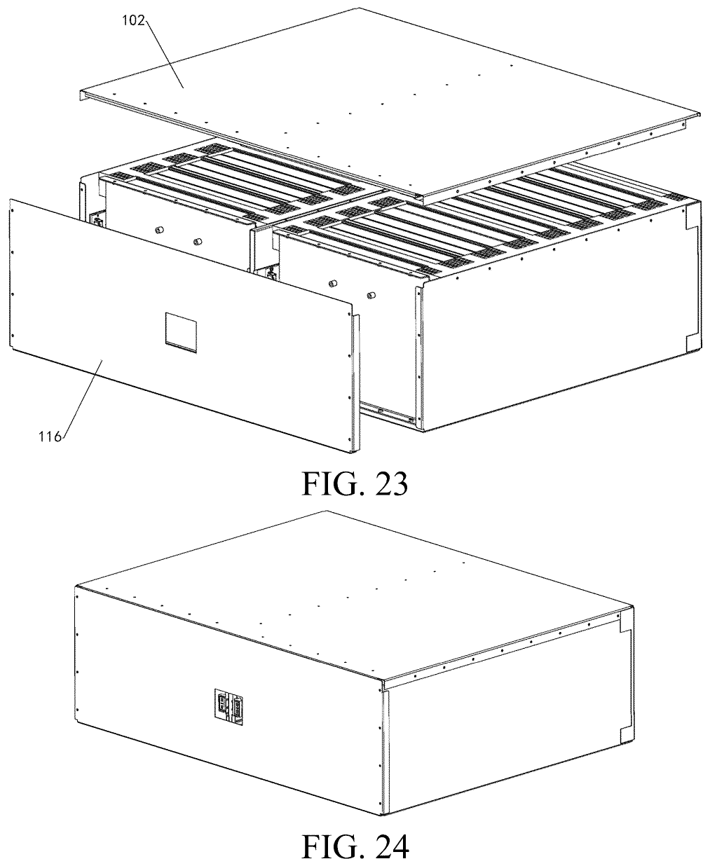

As shown in FIG. 22 and FIG. 23, in the embodiments, a pressing plate 114 is further disposed in the box body, and the pressing plate 114 is press-fitted on a top edge of the cell 200. A pressing edge 121 is disposed on two sides of the pressing plate 114, and a portion of a side edge at the top of the cell may be wrapped by using the pressing edge 121. An avoidance port 120 is further disposed on the pressing edge 121, to avoid a process convex edge of the cell.

In the embodiments, the electrical connection side plate and the electrical connector that are separately disposed are used, and the electrical connector is in clearance fit with and movably assembled on the electrical connection side plate, so that the pole of the cell can be detachably disposed in the insertion/removal channel, and a single cell can be pulled out when the single cell needs to be replaced or repaired because the cell fails or a problem occurs on the cell, thereby reducing repair costs and improving maintenance efficiency. In addition, a problem of poor module or pack formation that may be caused by a cell size deviation in the cell-to-module or cell-to-pack process is resolved, a risk of damage to the cell is reduced, and a cell-to-module or cell-to-pack tolerance is absorbed. In the embodiments, cell-to-module or cell-to-pack connections are performed in a physically detachable manner. During connections, cells are pressed by using a proper force, so that the cells are stably connected. Similarly, during replacement, a physical disassembly manner is used. Compared with welding, this manner can enable related parts to be reused. In addition, the electrical connector has degrees of freedom in six directions, to absorb a cell size tolerance. The electrical connector is disposed by using a combination of a flexible cable and a hard cable, so that strength required for connecting poles of cells to form a module or pack is provided, and a buffer is provided for the pole when the pre-tightening force is applied to the cell, thereby reducing a risk that the pole is torn due to a force and a risk of damage to the cell. The embodiments further provide an assembly process of the battery component. As shown in FIG. 15 to FIG. 24, the assembly process includes the following steps:
S1. assembling the pipeline limiting part 300 on the base plate 100 or the top plate 102 of the box body; and fastening the electrical connection side plate 104 to the inner sidewall of the box body; or
S1′. fastening the electrical connection side plate 104 to the inner sidewall of the box body; and assembling the pipeline limiting part 300 on the base plate 100 or the top plate 102 of the box body; and
S2. assembling the coolant plates 301 and the cells 200 in the box body; respectively installing, in the pipeline limiting parts 300, the inlet coolant pipe 302 and the outlet coolant pipe 303 that are connected to the plurality of coolant plates 301, and inserting the cell 200 into an insertion/removal interval between two adjacent coolant plates 301, so that the pole 201 of the cell 200 is plug-connected to the insertion/removal channel of the electrical connector (in this case, when the coolant plate 301 is not filled with water, the coolant plate 301 is flat, a clearance between the coolant plates 301 is relatively large, and the cell is not closely attached to the coolant plate after the cell is placed; and after the coolant plate is filled with water, the coolant plate is bulged and closely attached to the cell, and squeezes the cell because the coolant plate is limited by the cell and the box body), where the partition plate 103 is installed after all the coolant plates are installed; the partition plate 103 is installed on a side of a cell layout direction; the partition plate 103 is used to restrict the cell and a coolant system from being excessively expanded, and has a limiting function; and the partition plate may be further used to hang electrical elements such as a BMU; or
S2′: assembling the coolant plates 301 and the cells 200 in the box body; and inserting the cell 200 into the insertion/removal channel of the electrical connector, where a coolant plate insertion/removal clearance is reserved between adjacent cells 200, and respectively inserting the plurality of coolant plates 301 into corresponding coolant plate insertion/removal clearances while enabling the inlet coolant pipe 302 and the outlet coolant pipe 303 that are connected to the plurality of coolant plates 301 to be respectively installed in the pipeline limiting parts 300.

The pressing plate is installed after assembly of the cell and the coolant plate is completed. The pressing plate is used to fasten and protect the cell, and can reduce misalignment caused by vibration during transportation of the pack. Finally, the top plate and the end plate are installed.

When the electrical connection side plate is installed, a guide post 115 is disposed on a side plate of the box body, and the electrical connection side plate may be first perforated and hung to the guide post 115, and then tightened and fastened by using a bolt. A sampling plate 400 is installed on the electrical connection side plate after installation of the electrical connection side plate is completed. The sampling plate 400 may be configured to collect a voltage of the electrical connector and a working temperature of the cell. In a case of an exception in a working process, the sampling plate 400 can find the exception and give an alarm in a timely manner.

In the assembly process in the embodiments, the pipeline limiting part and the electrical connection side plate may be assembled in any order, which does not cause interference. The cell and the coolant plate may also be assembled in any order. In a preferred solution of the embodiments, the step of S2 is used, to be specific, the coolant plates are assembled before the cells. Because the coolant plate and the coolant pipes are connected together to form a whole, first packing the whole into the box body during assembly makes the process easier to implement. Then the cell is inserted between two coolant plates.

Connections in the assembly process, the cell-to-module or cell-to-pack process, and the coolant system in the embodiments are all performed in an insertion/removal manner, and therefore, a cell may be physically detached for replacement when a problem occurs on the cell. Compared with welding, this manner can enable related parts to be reused. In addition, the electrical connection side plate can absorb a cell size tolerance, so that a risk that the pole is torn due to a force and a risk of damage to the cell are reduced.

In the descriptions of the present invention, an orientation or positional relationship indicated by terms “up”, “down”, “front”, “back”, “left”, “right”, “top”, “bottom”, “inside”, “outside”, “axial”, “circumferential”, and the like is an orientation or positional relationship shown based on the accompanying drawings, is intended only to facilitate the descriptions of the present invention and simplification of the descriptions rather than indicating or implying that an apparatus or an element indicated must have a specific orientation, or be constructed and operated in a specific orientation, and therefore cannot be construed as a limitation to the present invention.

In addition, terms “first” and “second” are used only for description purposes, and cannot be understood as an indication or an implication of relative importance or an implicit indication of a quantity of indicated technical features. Therefore, features limited by “first” and “second” may explicitly or implicitly include at least one such feature. In the description of the present invention, “a plurality of” means at least two, for example, two or three, unless otherwise specifically limited.

In the present invention, unless otherwise specified and limited, terms such as “install”, “connect to each other”, “connect”, and “fasten” should be understood in a broad sense. For example, the term may be a fixed connection, a detachable connection, or integration; may be a mechanical connection or an electrical connection; or may be a direct connection, an indirect connection using an intermediate medium, a connection inside two elements, or an interaction relationship between two elements, unless otherwise specifically limited. A person of ordinary skill in the art may understand specific meanings of the foregoing terms in the present invention based on specific conditions.

In the present invention, unless otherwise specified and limited, that a first feature is “above” or “below” a second feature may be that the first feature is in direct contact with the second feature, or the first feature and the second feature are in indirect contact using an intermediate medium. In addition, that the first feature is “above” the second feature may be that the first feature is directly above or obliquely above the second feature, or merely indicate that the first feature is higher than the second feature. That the first feature is “below” the second feature may be that the first feature is directly below or obliquely below the second feature, or merely indicate that the first feature is lower than the second feature.

In the descriptions of this specification, descriptions provided with reference to terms such as “an embodiment”, “some embodiments”, “an example”, “a specific example”, or “some examples” intend to mean that a specific feature, structure, material, or characteristic described with reference to the embodiment or example is included in at least one embodiment or example of the present invention. In this specification, illustrative expressions of the foregoing terms are not necessarily intended for the same embodiment or example. In addition, the described specific feature, structure, material, or characteristic can be properly combined in any one or more embodiments or examples. In addition, a person skilled in the art can integrate and combine different embodiments or examples and features in different embodiments or examples described in this specification, provided that the embodiments or the examples and the features do not conflict with each other.

Although the embodiments of the present invention have been shown and described above, it may be understood that the foregoing embodiments are examples and cannot be understood as a limitation on the present invention. A person of ordinary skill in the art may make changes, modifications, replacements, and variations to the foregoing embodiments within the scope of the present invention.

What is claimed is:

1. A battery component, comprising a box body, cells (200), electrical connection side plates (104), and electrical connectors, wherein the electrical connection side plate (104) is installed on an inner sidewall of the box body, the electrical connector is movably assembled on the electrical connection side plate (104) with a plurality of degrees of freedom, and an insertion/removal channel is disposed on the electrical connector; the cell (200) is detachably disposed inside the box body, and a pole (201) of the cell (200) is plug-connected to the insertion/removal channel; an assembly interlayer (105) is disposed on the electrical connection side plate (104), and a first through hole (106) that communicates with the assembly interlayer (105) is disposed on the electrical connection side plate (104); the electrical connector comprises a limiting sheet (107) and an insertion/removal piece (108), the limiting sheet (107) is movably assembled in the assembly interlayer (105) with a plurality of degrees of freedom, the insertion/removal piece (108) is fastened on the limiting sheet (107), and penetrates the first through hole (106), and the insertion/removal channel is disposed on the insertion/removal piece (108); and a side surface of the limiting sheet (107) elastically abuts against or is in clearance fit with an interlayer sidewall of the assembly interlayer (105), a buffer clearance (109) is reserved between a first peripheral edge of the limiting sheet (107) and a corresponding peripheral wall of the assembly interlayer (105), a second peripheral edge of the limiting sheet (107) elastically abuts against a corresponding peripheral wall of the assembly interlayer (105), and the second peripheral edge is located on a side of an axial insertion/removal terminating end of the insertion/removal channel.

2. The battery component according to claim 1, wherein a bent support structure (119) is disposed on the limiting sheet (107), and an edgefold of the bent support structure (119) elastically abuts against or is in clearance fit with the interlayer sidewall of the assembly interlayer (105); and
an elastic pad (110) is further disposed on the peripheral wall of the assembly interlayer (105), and the second peripheral edge of the limiting sheet (107) abuts against the elastic pad (110).

3. The battery component according to claim 1, wherein an axial opening is disposed on the insertion/removal channel, an axial insertion/removal starting end of the insertion/removal channel is a large head end (111), the axial insertion/removal terminating end of the insertion/removal channel is a small head end (112), and the pole (201) of the cell (200) is axially inserted from the large head end (111) of the insertion/removal channel.

4. The battery component according to claim 2, wherein an axial opening is disposed on the insertion/removal channel, an axial insertion/removal starting end of the insertion/removal channel is a large head end (111), the axial insertion/removal terminating end of the insertion/removal channel is a small head end (112), and the pole (201) of the cell (200) is axially inserted from the large head end (111) of the insertion/removal channel.

5. The battery component according to claim 1, further comprising pipeline limiting parts (300), a plurality of coolant plates (301), an inlet coolant pipe (302), and an outlet coolant pipe (303), wherein the pipeline limiting part (300) is installed on a base plate (100) or a top plate (102) of the box body, inlets and outlets of the plurality of coolant plates (301) are respectively connected to the inlet coolant pipe (302) and the outlet coolant pipe (303), and the inlet coolant pipe (302) and the outlet coolant pipe (303) are respectively detachably limited in corresponding pipeline limiting parts (300); and an insertion/removal interval for accommodating the cell (200) is reserved between two adjacent coolant plates (301), and the cell (200) is disposed in the insertion/removal interval.

6. The battery component according to claim 5, wherein a hanging channel (113) is further disposed on the electrical connection side plate (104), and an extension direction of the hanging channel (113) is the same as an extension direction of the insertion/removal channel; and a hanging block (305) is disposed on a side edge of the coolant plate (301), and the hanging block (305) is plug-connected to the hanging channel (113).

7. The battery component according to claim 5, wherein a pipeline groove (306) arranged perpendicularly to the coolant plate (301) is disposed on the pipeline limiting part (300), a groove opening of the pipeline groove (306) is disposed toward the insertion/removal channel, and an avoidance notch (307) for accommodating a corner (202) of the cell (200) is disposed on a groove wall of the pipeline groove (306).

8. The battery component according to claim 5, wherein the coolant plate (301) is a flexible coolant plate.

9. The battery component according to claim 1, wherein a plurality of rows of second through holes (11) are further disposed on a base plate (100) of the box body, each row of second through holes (11) comprises at least one second through hole (11), a spring (12) is connected to the base plate (100) at each second through hole (11), the spring (12) is disposed in correspondence with the second through hole (11), and the spring (12) protrudes from a side surface of the base plate (100).

10. The battery component according to claim 9, wherein the second through hole (11) and the spring (12) are formed on the base plate (100) by using a stamping process.

11. The battery component according to claim 1, wherein a pressing plate (114) is further disposed in the box body, and the pressing plate (114) is press-fitted on a top edge of the cell (200).

12. The battery component according to claim 1, wherein the limiting sheet (107) uses a flexible cable, and the insertion/removal piece (108) uses a hard cable.

13. An assembly process of the battery component according to claim 8, comprising the following steps:
S1. assembling the pipeline limiting part (300) on the base plate (100) or the top plate (102) of the box body; and fastening the electrical connection side plate (104) to the inner sidewall of the box body; or
S1′. fastening the electrical connection side plate (104) to the inner sidewall of the box body; and assembling the pipeline limiting part (300) on the base plate (100) or the top plate (102) of the box body; and
S2. assembling the coolant plates (301) and the cells (200) in the box body; respectively installing, in the pipeline limiting parts (300), the inlet coolant pipe (302) and the outlet coolant pipe (303) that are connected to the plurality of coolant plates (301), and inserting the cell (200) into an insertion/removal interval between two adjacent coolant plates (301), so that the pole (201) of the cell (200) is plug-connected to the insertion/removal channel of the electrical connector; or
S2′: assembling the coolant plates (301) and the cells (200) in the box body; and inserting the cell (200) into the insertion/removal channel of the electrical connector, wherein a coolant plate insertion/removal clearance is reserved between adjacent cells (200), and respectively inserting the plurality of coolant plates (301) into corresponding coolant plate insertion/removal clearances while enabling the inlet coolant pipe (302) and the outlet coolant pipe (303) that are connected to the plurality of coolant plates (301) to be respectively installed in the pipeline limiting parts (300).
